(19) United States
(12) Patent Application Publication
(10) Pub. No.: US 2003/0220025 A1
(43) Pub. Date: Nov. 27, 2003

(54) Terminal material strip assembly

(76) Inventors: Master Peng, Taipei (TW); Kevin Yeh, Taipei (TW)

Correspondence Address: Master Peng, 235 Chung-Ho, Box 8-24, Taipei, R.O.C., TW

(21) Appl. No.: 10/429,340

(22) Filed: Apr. 30, 2003

(30) Foreign Application Priority Data
May 21, 2002 (CN) 022340351

(51) Int. Cl. H01R 9/24

(52) U.S. Cl. 439/885

(57) ABSTRACT

A terminal material strip assembly comprises a material strip and a bank of first terminals and second terminals. The first terminals and second terminals are alternatively arranged, a plurality of combining portions are punched and extended from one side of the base. The first terminal has a first body portion, and the second terminal has a second body portion. Each first terminal is connected to the combining portion of the base so as to form a first concave bending portion; and each second terminal is connected to one combining portion of the base so as to form a second concave bending portion. The first concave bending portion and the second concave bending portion are not at the same straight line.

### FIELD OF THE INVENTION

The present invention relates to terminal material strip assemblies, and particularly to a terminal material strip assembly which can generate two kinds of different terminals and can be installed to electric connectors.

### BACKGROUND OF THE INVENTION

In general, an electric connector is installed with a plurality of conductive terminals. In general, the conducting terminals have similar shapes and are regularly arranged in the electric connector. To be effectively operated in welding and assembly, a metal material strip is used. The material strip is punched continuously to form a semi-finished good containing part of the material strip and a plurality of terminals. Then automatic welding and assembly are performed by transferring and the positioning the material strip.

Referring to FIG. 1, an automatic terminal material strip assembly 1 for producing two kinds of terminals is illustrated. The terminal material strip assembly comprises a metal material strip 10, a plurality of first terminals 11, a plurality of second terminals 12, and a plurality of combining portions 13 punching from the material strip 10. The first terminals 11 and second terminals 12 are different in shapes. Thereby, the first terminals 11, second terminals 12 and the material strip 10 are formed as an integral body. The terminals are arranged with predetermined spaces. Each of the first terminals 11 and second terminals 12 has a distal portion 111, 121 which are vertically connected to the material strip 10 and then are further vertically bent. The vertical height of the distal portion 121 of the second terminal 12 is higher than that of the distal portion 111 of the first terminal 11. Thereby, when the terminal material strip assembly is assembled to an electric connector (not shown), it can be removed from the combining portion 13 of the material strip 10. Thereby, the combining portions 13 of the first terminals 11 and second terminals 12 are punched with contact portions 131 and second concave bending portions 132. The first concave bending portions are parallel to the second terminals. Thereby, the material strip can be broken in assembly. However, in the prior art, since the first concave bending portion 131 and second concave bending portion 132 are parallel arranged (especially for material strips of small terminals, or the gaps between the first terminals and second terminals are very small), the material strip must be punched twice. For example, the first terminal 11 is punched firstly and then the second terminal 12 is punched by adjusting a mold. Finally, the first concave bending portion 131 and second concave bending portion 132 are punched. The time period is long and the cost is high.

### SUMMARY OF THE INVENTION

Accordingly, the primary object of the present invention is to provide a terminal material strip assembly comprising a material strip and a bank of first terminals and second terminals; the first terminals and second terminals are alternatively arranged; a plurality of combining portions are punched and extended from one side of the base. The first terminal has a first body portion, and the second terminal has a second body portion. Each first terminal is connected to the combining portion of the base so as to form a first concave bending portion; and each second terminal is connected to one combining portion of the base so as to form a second concave bending portion. The first concave bending portion and the second concave bending portion are not at the same straight line.

The various objects and advantages of the present invention will be more readily understood from the following detailed description when read in conjunction with the appended drawing.

### BRIEF DESCRIPTION OF THE DRAWINGS

FIG. 1 is a partial schematic view of a prior art terminal material.

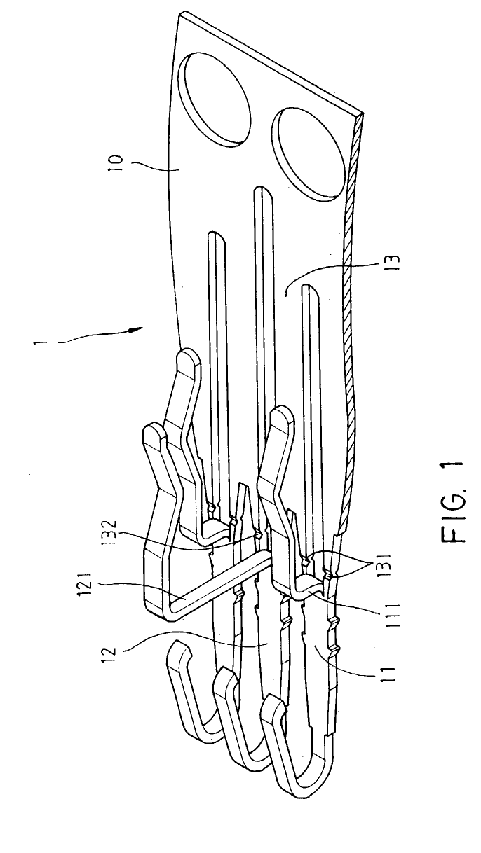

FIG. 2 is an elevational view of the terminal material strip of the present invention.

FIG. 3 is partial schematic perspective view of the terminal material strip of the present invention.

FIG. 4 is a lateral cross section view showing that in the present invention, a terminal material strip is assembled in the insulating body of an electric connector, where other portions of the terminal material strip has been cut.

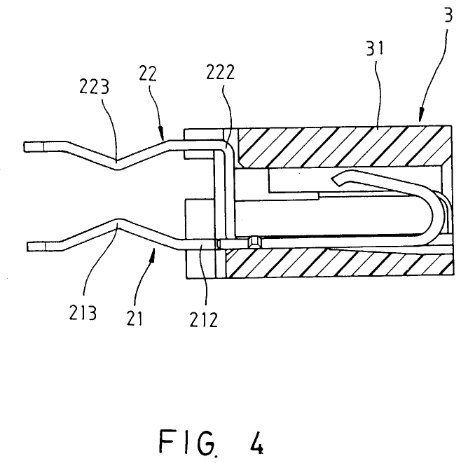

### DETAILED DESCRIPTION OF THE PREFERRED EMBODIMENTS

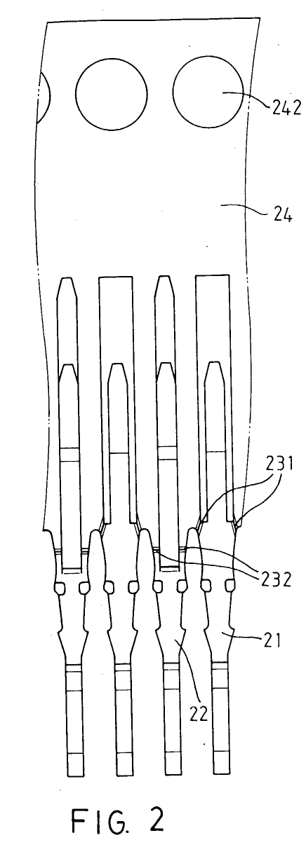

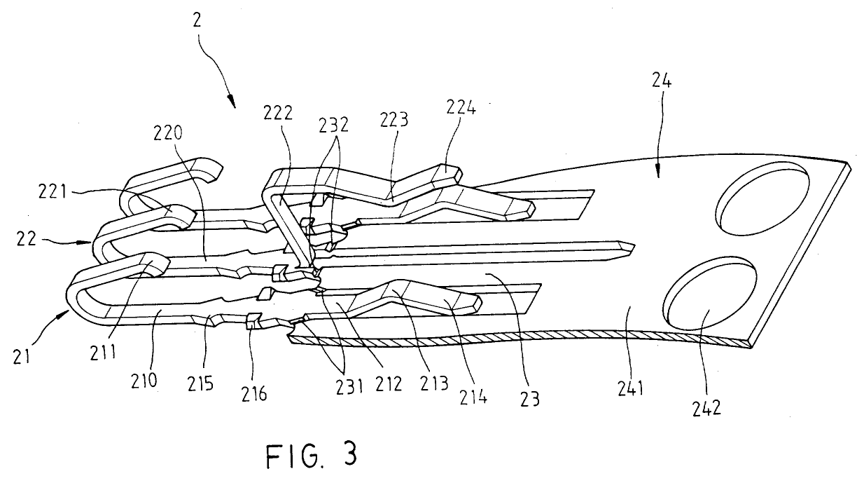

Referring to FIGS. 2 and 3, the elevational view and schematic view of the terminal material strip assembly 2 of the present invention is illustrated. The terminal material strip assembly 2 includes a material strip 24 and a bank of first terminals 21 and second terminals 22. The first terminals 21 and second terminals 22 are alternatively arranged. The material strip 24 is long piece-like material and includes a base 241 and a plurality of positioning holes 242 spaced with a predetermined distance and formed by punching. By the positioning holes 242, the material strip 24 is transferred and supported conveniently. A plurality of combining portions 23 are punched and extended from one side of the base 241.

The first terminal 21 has a body portion 210, a contact portion 211 extending reversely from one end of the body portion 210; a connecting portion 212 extending from another end of the body portion 210, and a distal portion 214 extending from one end of the connecting portion 222 (the end extending the distal portion is opposite to the end connecting the connecting portion 212), and a resisting portion 213 is concave upwards from the connecting portion 212 and the distal portion 214. Two sides of the body portion 210 are installed with a first interfering portion 215 and a second interfering portion 216, respectively. By the interfering portions, the terminal material strip assembly of the present invention can be connected to an insulating body 31 of an electric connector 3 easily.

The structure of the second terminal 22 is similar to the second terminal 21. The second terminal 22 has a body portion 220, a contact portion 221 extending reversely from one end of the body portion 220; a connecting portion 222 extending from another end of the body portion 220, and a distal portion 224 extending from one end of the connecting portion 222 (the end extending the distal portion is opposite to the end connecting the body portion 220). The connecting portion 222 of the second terminal 22 has a vertical structure and one end of the connecting portion 212 is vertically connected to one end of the body portion 220. A resisting portion 223 is concave downwards from the connecting portion 222 and the distal portion 224. Thereby, a tip of the resisting portion 213 of the first terminal 21 faces towards a tip of the resisting portion 223 of the second terminal 22.

Two sides of the body portion 210 are installed with a first interfering portion 215 and a second interfering portion 216. By the interfering portions, the terminal material strip assembly of the present invention can be connected to an insulating body 31 of an electric connector 3 easily.

The first terminal 21 is connected to the combining portion 23 of the base 241 so as to form an inclined first concave bending portion 231. The second terminal 22 is connected to the combining portion 23 of the base 241 so as to form a second concave bending portion 232. The first concave bending portions 231 and the second concave bending portions 232 are not at the same line. For the first terminal 21, the body portion 210 and the connecting portion 212 ate arranged at opposite sides of the first concave bending portion 231. For the second terminal 22, the body portion 220 and the vertically arranged connecting portion 222 are arranged at the same side of the second concave bending portion 232. By above mentioned, first concave bending portions 231, second concave bending portions 232, connecting portions 212, and connecting portions 222, the first terminals 21 and second terminals 22 can be formed integrally. It is needless to adjust the mold further so as to reduce the manufacturing time and cost.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A terminal material strip assembly comprising a material strip and a bank of first terminals and second terminals; the first terminals and second terminals being alternatively arranged; a plurality of combining portions being punched and extended from one side of the base; wherein:
the first terminal has a first body portion, and the second terminal has a second body portion, each first terminal is connected to the combining portion of the base so as to form a first concave bending portion; and each second terminal is connected to one combining portion of the base so as to form a second concave bending portion; the first concave bending portion and the second concave bending portion ate not at the same straight line.

2. The terminal material strip assembly as claim in claim 1, wherein the first terminal has a first body portion, a first contact portion extending from one end of the first body portion; a connecting portion extending from another end of the first body portion, and a first distal portion extending from one end of the first connecting portion; the end of the first connecting portion extending the distal portion is opposite to an end connecting the first body portion;
the second terminal has a second body portion; a second contact portion extending from the second body portion; a second connecting portion vertically extended from another end of the second body portion; and a second distal portion extending from one end of the second connecting portion; the end of the second connecting portion extending the second distal portion is opposite to the end connecting the second body portion.

3. The terminal material strip assembly as claim in claim 2, wherein the first concave bending portion of the first terminal is inclined to the first body portion and the first connecting portion.

4. The terminal material strip assembly as claim in claim 2, wherein the second concave bending portion of the second terminal is transversal to the second body portion and the second connecting portion.

5. The terminal material strip assembly as claim in claim 4, wherein for the first terminal, the first body portion and the second connecting portion are arranged at opposite sides of the first concave bending portion; for the second terminal, the second body portion and the vertically arranged second connecting portion are arranged at the same side of the second concave bending portion.

6. The terminal material strip assembly as claim in claim 5, wherein each body portion of the first terminal and the second terminal is formed with a first interfering portion and a second interfering portion.

7. The terminal material strip assembly as claim in claim 6, wherein a first resisting portion is formed between the first connecting portion and the first distal portion of each first terminal.

8. The terminal material strip assembly as claim in claim 6, wherein a second resisting portion is formed between the second connecting portion and the second distal portion of each first terminal.

9. The terminal material strip assembly as claim in claim 9, wherein the base of the material strip is formed with a plurality of positioning holes which are spaced with a predetermined spaced and are formed by punching.
